(19) United States
(12) Patent Application Publication
(10) Pub. No.: US 2020/0064834 A1
(43) Pub. Date: Feb. 27, 2020

(54) OPERATION SWITCHING SUPPORT DEVICE AND OPERATION SWITCHING SUPPORT METHOD

(71) Applicant: OMRON CORPORATION, Kyoto-shi, Kyoto (JP)

(72) Inventors: Tadashi HYUGA, Hirakata-shi (JP); Hatsumi AOI, Kyotanabe-shi (JP); Mei UETANI, Uji-shi (JP)

(73) Assignee: OMRON CORPORATION, Kyoto-shi, Kyoto (JP)

(21) Appl. No.: 16/466,052

(22) PCT Filed: Nov. 27, 2017
(86) PCT No.: PCT/JP2017/042379

§ 371 Date: Jun. 3, 2019

(30) Foreign Application Priority Data
Feb. 17, 2017 (JP) 2017-027899

(51) Int. Cl. G05D 1/00; B60W 30/182; B60W 40/08; B60W 50/14; G01C 21/26

(52) U.S. Cl. CPC G05D 1/0061; B60W 30/182; G01C 21/26; B60W 50/14; B60W 40/08

(57) ABSTRACT

An operation switching support device whereby some of the labor of safety checking motion is taken off a driver at the time of switching from automatic operation to manual operation, and the switching to the manual operation can be conducted just with required safety checking motions, is provided, the operation switching support device, including an area checking urging processing part for conducting processing of urging checking of areas visually unconfirmed when the driver is decided to be in a state of being able to perform the manual operation by a driver state deciding part and the areas visually unconfirmed are decided to be present by a visual confirmation area deciding part, and a signal output part

for outputting a signal for permitting switching from the automatic operation to the manual operation to an automatic operation control device after the urging processing.

### TECHNICAL FIELD

The present invention relates to an operation switching support device and an operation switching support method, and more particularly, to an operation switching support device and an operation switching support method for supporting switching from automatic operation in which traveling control of a vehicle is automatically conducted to manual operation by a driver.

### BACKGROUND ART

In recent years, research and development aimed at realizing automatic operation in which traveling control of a vehicle is automatically conducted has been actively conducted. As the technical levels of the automatic operation, there are several levels from a level in which the traveling control (such as acceleration, steering, and braking) is partially automated, a level in which such partially automated control is combined and sophisticated, farther to a level of full automation. In many of the levels, it is assumed that a situation of switching between the automatic operation and manual operation during traveling would occur. During the automatic operation, there are possibilities that the driver may do some work other than vehicle operation or that the arousal level of the driver may become lower. Therefore, it is required to give support to the driver in order that the transfer from the automatic operation to the manual operation is safely carried out, and the techniques related to those have been also examined.

For example, in the below-mentioned Patent Document 1, a technique is disclosed, wherein indicators for safety checking are presented on places where the safety should be confirmed in a vehicle such as a front window, a room mirror, and left and right side windows when an automatic operation section comes to an end, the user's pointing motions to the presented indicators are detected by a camera, and based on the detection results, the vehicle is controlled. For example, the automatic traveling is released after reducing the speed of the vehicle or increasing the distance between vehicles, in cases where there is a possibility of the driver's neglecting to take the pointing motions.

### Problems to Be Solved by the Invention

However, in the technique described in the Patent Document 1, the driver is required to take pointing motions one by one to all the indicators presented on the front window, room mirror, and left and right side windows, every time the automatic operation is switched to manual operation, leading to labor and inconvenience in safety confirmation.

### PRIOR ART DOCUMENT

### Patent Document

Patent Document 1: Japanese Patent Application Laid-Open Publication No. 2015-184975

### SUMMARY OF THE INVENTION

### Means for Solving Problem and the Effect

The present invention was developed in order to solve the above problem, and it is an object of the present invention to provide an operation switching support device and an operation switching support method whereby switching to manual operation can be safely conducted without taking much time and effort to confirm safety by urging more appropriate safety checking when automatic operation is switched to the manual operation.

In order to achieve the above object, an operation switching support device according to a first aspect of the present invention is characterized by supporting switching from automatic operation in which traveling control of a vehicle is automatically conducted to manual operation by a driver, the operation switching support device comprising:

a driver state deciding part for deciding whether the driver is in a state of being able to perform the manual operation using data detected by a driver state detecting part for detecting a state of the driver, before switching to the manual operation;

a visual confirmation area deciding part for deciding the presence or absence of areas visually unconfirmed by the driver using data detected by a visual line detecting part for detecting a visual line of the driver, before switching to the manual operation;

an area checking urging processing part for conducting processing of urging checking of the areas visually unconfirmed, when the driver is decided to be in the state of being able to perform the manual operation by the driver state deciding part and the areas visually unconfirmed are decided to be present by the visual confirmation area deciding part; and

a signal output part for outputting a signal for permitting switching from the automatic operation to the manual operation to an automatic operation control part, when a predetermined condition is satisfied after the urging processing by the area checking urging processing part.

Using the operation switching support device according to the first aspect of the present invention, when the driver is decided to be in the state of being able to perform the manual operation by the driver state deciding part and the areas visually unconfirmed are decided to be present by the visual confirmation area deciding part before switching to the manual operation, the urging processing of urging the checking of the areas visually unconfirmed is conducted. Since the checking of the areas visually unconfirmed is urged by the urging processing, the driver can grasp all the surroundings of the vehicle by looking at the areas visually unconfirmed. Consequently, some of the load of safety checking motion is taken off the driver, and the switching to the manual operation can be safely conducted just with required checking motions, without taking much time and effort.

The operation switching support device according to a second aspect of the present invention is characterized by comprising a visual confirmation deciding part for deciding whether the areas visually unconfirmed were visually confirmed by the driver using the data detected by the visual line detecting part, after the urging processing by the area checking urging processing part, wherein

the predetermined condition is that it is decided that the areas visually unconfirmed were visually confirmed by the driver by the visual confirmation deciding part, in the operation switching support device according to the first aspect of the present invention.

Using the operation switching support device according to the second aspect of the present invention, when it is decided that the areas visually unconfirmed were visually confirmed by the driver by the visual confirmation deciding part, the signal for permitting the switching to the manual operation is output to the automatic operation control part. Consequently, the switching to the manual operation can be conducted after all the surroundings of the vehicle were confirmed by the driver, leading to enhanced safety at the time of switching.

The operation switching support device according to a third aspect of the present invention is characterized by comprising a visual checking necessity deciding part for deciding whether the areas visually unconfirmed need visual checking, when the areas visually unconfirmed are decided to be present by the visual confirmation area deciding part, wherein

the area checking urging processing part conducts the processing of urging checking of the areas decided to need visual checking by the visual checking necessity deciding part, among the areas visually unconfirmed, in the operation switching support device according to the first or second aspect of the present invention.

Using the operation switching support device according to the third aspect of the present invention, when the areas visually unconfirmed are decided to be present, whether the areas visually unconfirmed need visual checking is decided. And the urging processing of urging the checking of the areas decided to need visual checking among the areas visually unconfirmed is conducted. Consequently, the driver only has to check the areas decided to need visual checking among the areas visually unconfirmed. Before switching to the manual operation, without loss of safety, some of the load of safety checking motion can be further taken off the driver.

The operation switching support device according to a fourth aspect of the present invention is characterized by the visual checking necessity deciding part which decides whether the areas visually unconfirmed need visual checking, using at least one of planned traveling route data of the vehicle and detection data of objects to be monitored existing in the periphery of the vehicle, in the operation switching support device according to any one of the first to third aspects of the present invention.

Using the operation switching support device according to the fourth aspect of the present invention, whether the areas visually unconfirmed need visual checking is decided, using the planned traveling route data of the vehicle or the detection data of the objects to be monitored. By using the planned traveling route data of the vehicle or the detection data of the objects to be monitored in the decision, it is possible to allow the driver to appropriately check only the areas necessary for safety confirmation according to the surroundings of the vehicle which change every moment.

The operation switching support device according to a fifth aspect of the present invention is characterized by the signal output part which outputs the signal for permitting the switching, when the driver is decided to be in the state of being able to perform the manual operation by the driver state deciding part and the areas visually unconfirmed are decided not to be present by the visual confirmation area deciding part, in the operation switching support device according to any one of the first to fourth aspects of the present invention.

Using the operation switching support device according to the fifth aspect of the present invention, when the driver is decided to be in the state of being able to perform the manual operation by the driver state deciding part and the areas visually unconfirmed are decided not to be present by the visual confirmation area deciding part, that is, when the driver is in the state of being able to perform the manual operation and all the surroundings of the vehicle have been confirmed by the driver, it is possible to swiftly switch to the manual operation.

An operation switching support method according to the present invention is characterized by being conducted by a computer to be mounted on a vehicle switchable from automatic operation in which traveling control of the vehicle is automatically conducted to manual operation by a driver, the operation switching support method comprising the steps of:

driver state decision for deciding whether the driver is in a state of being able to perform the manual operation using data detected by a driver state detecting part for detecting a state of the driver, before switching to the manual operation;

visual confirmation area decision for deciding the presence or absence of areas visually unconfirmed by the driver using data detected by a visual line detecting part for detecting a visual line of the driver, before switching to the manual operation;

area checking urging processing for conducting processing of urging checking of the areas visually unconfirmed, when the driver is decided to be in the state of being able to perform the manual operation in the driver state decision step and the areas visually unconfirmed are decided to be present in the visual confirmation area decision step; and

signal output for outputting a signal for permitting switching from the automatic operation to the manual operation to an automatic operation control part, when a predetermined condition is satisfied after the urging processing in the area checking urging processing step.

In the operation switching support method, when the driver is decided to be in the state of being able to perform the manual operation in the driver state decision step and the areas visually unconfirmed are decided to be present in the visual confirmation area decision step before switching to the manual operation, the area checking urging processing step for urging checking of the areas visually unconfirmed is conducted. Since the checking of the areas visually unconfirmed is urged in the area checking urging processing step, the driver can grasp all the surroundings of the vehicle by looking at the areas visually unconfirmed. Consequently, some of the load of safety checking motion can be taken off the driver, and the switching to the manual operation can be safely conducted just with required checking motions, without taking much time and effort.

### BRIEF DESCRIPTION OF DRAWINGS

FIG. 1 is a block diagram schematically showing a construction of an automatic vehicle operation system including an operation switching support device according to a first embodiment of the present invention;

FIG. 2 is a block diagram schematically showing a construction of the operation switching support device according to the first embodiment;

FIG. 3 is a flowchart showing processing operations conducted by the operation switching support device according to the first embodiment and an automatic operation control device;

FIG. 4 is a block diagram schematically showing a construction of an operation switching support device according to a second embodiment; and

FIG. 5 is a flowchart showing processing operations conducted by the operation switching support device according to the second embodiment.

### MODE FOR CARRYING OUT THE INVENTION

The embodiments of the operation switching support device and the operation switching support method according to the present invention are described below by reference to the Figures. The below-described embodiments are preferred embodiments of the present invention, and various technically preferred limitations are included therein. However, the scope of the present invention is not limited to these modes, as far as there is no description particularly limiting the present invention in the following explanations.

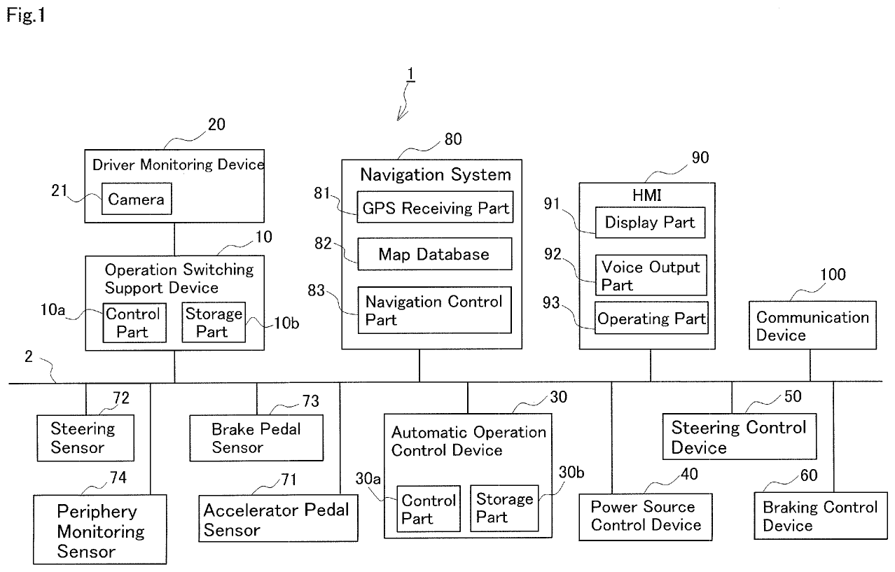

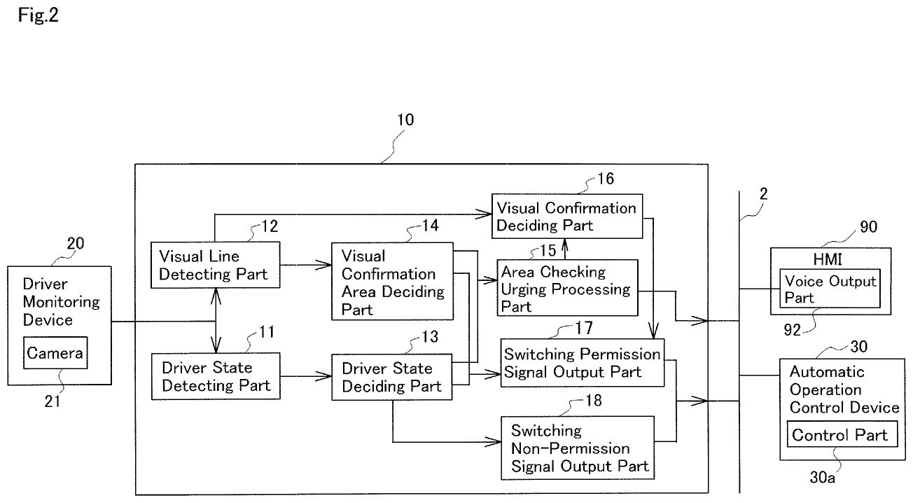

FIG. 1 is a block diagram schematically showing a construction of an automatic vehicle operation system including an operation switching support device according to a first embodiment. FIG. 2 is a block diagram schematically showing a construction of the operation switching support device according to the first embodiment.

An automatic vehicle operation system 1 comprises an operation switching support device 10 and an automatic operation control device 30, having an automatic operation function automatically conducting traveling control such as acceleration, steering and braking of a vehicle, and a manual operation function wherein the traveling control is conducted through a driver's operation.

The automatic vehicle operation system 1, comprising the operation switching support device 10 and the automatic operation control device 30, further comprises various kinds of sensors and control devices required for controlling automatic operation and manual operation, such as a driver monitoring device 20, a power source control device 40, a steering control device 50, a braking control device 60, an accelerator pedal sensor 71, a steering sensor 72, a brake pedal sensor 73, a periphery monitoring sensor 74, a navigation system 80, an HMI (Human Machine Interface) 90 and a communication device 100. These various kinds of sensors and control devices are connected through a communication bus 2.

The operation switching support device 10 is a device which conducts various kinds of control such as checking urging processing or signal output processing for supporting switching from automatic operation to manual operation, having a control part 10a, a storage part 10b, an input part and an output part of signals of every kind, neither of them shown, and the like. The control part 10a, having a microprocessor including a CPU, a ROM, a RAM and the like, conducts various kinds of control by reading programs stored in the ROM into the RAM so as to allow the CPU to conduct the programs. The operation switching support device 10 is connected to the automatic operation control device 30, driver monitoring device 20, periphery monitoring sensor 74, navigation system 80, HMI 90, communication device 100 and the like, and on the basis of information acquired from these devices, it conducts control to output a signal for permitting or not permitting the switching from automatic operation to manual operation to the automatic operation control device 30.

The driver monitoring device 20 comprises a camera 21 or more for imaging a state of the driver. The driver monitoring device 20 is installed in a position to be able to photograph the driver (for example, in front of the driver's seat and in the state of facing the driver's seat). Image data of the driver successively picked up by the driver monitoring device 20 is output to the operation switching support device 10 with a prescribed timing. The driver monitoring device 20 and the operation switching support device 10 may be constructed in one body.

As sensors for detecting the state of the driver, besides the driver monitoring device 20, a steering wheel contact sensor, a seating sensor, a vital information sensor and the like, which are not shown, may be installed. The steering wheel contact sensor or the seating sensor is constructed with a pressure-sensitive sensor, an electrostatic capacitance type sensor and the like installed on the steering wheel or the seat, respectively. The vital information sensor is a sensor which detects vital information (such as the pulse, blood pressure and brain waves) of the driver, being constructed with a wearable sensor put on by the driver, a non-contact sensor using radio waves (such as microwaves) and the like. Or the driver monitoring device 20 and these sensors may be combined.

In order to make it possible to image the driver state day and night, the camera 21 to be mounted on the driver monitoring device 20 comprises, for example, an infrared light camera part (including an image sensor such as a CCD or a CMOS), an infrared light emitting part (an LED), an interface part, and a camera control part for controlling each of these parts. The camera control part controls the infrared light camera part and the infrared light emitting part so as to allow the infrared light emitting part to emit infrared light (such as near-infrared rays) and allow the infrared light camera part to pick up the reflected light thereof.

The automatic operation control device 30 is a device which conducts various kinds of control related to the automatic operation of the vehicle, consisting of an electronic control unit having a control part 30a, a storage part 30b, an input part and an output part of signals of every kind, neither of them shown, and the like. The control part 30a, having a microprocessor including a CPU, a ROM, a RAM and the like, conducts various kinds of vehicle control by reading programs stored in the ROM into the RAM so as to allow the CPU to conduct the programs.

The automatic operation control device 30 is connected to, besides the operation switching support device 10, the power source control device 40, steering control device 50, braking control device 60, accelerator pedal sensor 71, steering sensor 72, brake pedal sensor 73, periphery monitoring sensor 74, navigation system 80, HMI 90, communication device 100 and the like. On the basis of information acquired from these devices, the automatic operation control device 30 outputs control signals for conducting automatic operation to each control device so as to conduct automatic traveling control of the vehicle (such as automatic steering control, automatic speed regulation control and automatic braking control).

What the automatic operation means is to allow a vehicle to automatically travel along a road through the control conducted by the automatic operation control device 30 without a driver's driving operation. For example, an operation state where the vehicle is allowed to automatically travel toward a selected destination is included. And when a predetermined condition is satisfied, the automatic operation control device 30 finishes (releases) the automatic operation. For example, the automatic operation control device 30 finishes the automatic operation, when it is decided that the vehicle during automatic operation reached a previously selected finish point of automatic operation. Or the automatic operation control device 30 may conduct control for finishing the automatic operation, when the driver performed an automatic operation release operation (e.g., an operation of an automatic operation release button, the driver's operation of the steering wheel, accelerator or brake). The manual operation means an operation state where the vehicle is allowed to travel mainly through the driver's driving operation.

The power source control device 40 is an electronic control unit which controls the power source such as an engine or a motor of the vehicle. The power source control device 40 controls the driving force of the vehicle, for example, by controlling the fuel supply and air supply to the engine, or the power supply to the motor. In the automatic operation mode, it controls the driving force of the vehicle according to a control signal from the automatic operation control device 30.

The steering control device 50 is an electronic control unit which controls an electric power steering system of the vehicle. The steering control device 50 controls the steering torque of the vehicle by driving an assist motor which controls the steering torque of the vehicle in the electric power steering system. In the automatic operation mode, it controls the steering torque according to a control signal from the automatic operation control device 30.

The braking control device 60 is an electronic control unit which controls the brake system of the vehicle. The braking control device 60 controls the braking force applied to the wheels of the vehicle, for example, by regulating the liquid pressure applied to a hydraulic brake system. In the automatic operation mode, it controls the braking force to the wheels according to a control signal from the automatic operation control device 30.

The accelerator pedal sensor 71 is a sensor which detects a stepping quantity of the accelerator pedal (the position of the accelerator pedal). A signal according to the stepping quantity of the accelerator pedal detected by the accelerator pedal sensor 71 is output to the automatic operation control device 30 or the power source control device 40.

The steering sensor 72, being located, for example, on a steering shaft of the vehicle, is a sensor which detects the steering torque applied to the steering wheel by the driver. A signal according to an operation of the steering wheel by the driver detected by the steering sensor 72 is output to the automatic operation control device 30 or the steering control device 50.

The brake pedal sensor 73 is a sensor which detects a stepping quantity of the brake pedal (the position of the brake pedal) or an operating force (such as a stepping force) thereof. A signal according to the stepping quantity or operating force of the brake pedal detected by the brake pedal sensor 73 is output to the automatic operation control device 30 or the braking control device 60.

The periphery monitoring sensor 74 is a sensor which detects an object (e.g., a moving object such as a car, a bicycle or a person, road surface signs (such as white lines), a guardrail, a medial strip, a structure which affects traveling of the vehicle) existing in the periphery of the vehicle. The periphery monitoring sensor 74 includes at least one selected from among a front monitoring camera, a rear monitoring camera, a Radar device, a LIDAR device and an ultrasonic sensor. The detection data of the object detected by the periphery monitoring sensor 74 is output to the operation switching support device 10 or the automatic operation control device 30. As the front monitoring camera or rear monitoring camera, a stereo camera or a monocular camera can be adopted. The Radar device sends radio waves such as millimeter waves to the surroundings of the vehicle, and receives the radio waves reflected by the object existing in the surroundings of the vehicle, so as to detect the position, direction, distance and the like of the object. The LIDER device sends a laser light to the surroundings of the vehicle and receives the light reflected by the object existing in the surroundings of the vehicle, so as to detect the position, direction, distance and the like of the object.

The navigation system 80 is a device which conducts route guidance to a selected destination and the like, comprising a GPS receiving part 81, a map database 82, a navigation control part 83, and a display part, an operating part, a speed sensor, an acceleration sensor and a yaw rate sensor which are not shown. The GPS receiving part 81 calculates position information (such as the longitude and latitude) of the vehicle. The map database 82 includes high precision map data for automatic operation control as well as map data for guidance display. In these items of map data, information with which a route can be prepared to the lane, such as the position on the road (such as an intersection or a fork), the type of the road (such as an expressway or an ordinary road), the shape thereof (such as a gradient or the radius of curvature), and detailed road information (such as lanes, a traffic jam or lane restriction information), is included.

On the basis of the position information of the vehicle calculated by the GPS receiving part 81 and the map information of the map database 82, the navigation system 80 calculates the road and the lane on which the vehicle travels, computes a route from the current position of the vehicle to a destination, displays the route on the display part, and conducts voice route guidance. The position information of the vehicle, information of the traveling road, information of guided route, etc., obtained by the navigation control part 83 are output to the operation switching support device 10 or the automatic operation control device 30. The information of the guided route also includes information related to control of automatic operation such as start/finish points of an automatic operation section and an advance notice point of finish (release) of the automatic operation.

The HMI (Human Machine Interface) 90 is a device which, on the basis of a signal sent from the operation switching support device 10 or the automatic operation control device 30, allows the driver to know visually or auditorily the operation state or release information of the automatic vehicle operation system 1, and outputs an operation signal related to automatic operation control to the operation switching support device 10 or the automatic operation control device 30. The HMI 90 comprises, for example, a display part 91 installed at a position easy to be viewed by the driver, a voice output part 92, an operating part 93 and a microphone not shown. The driver monitoring device 20 may be incorporated into the HMI 90.

The communication device 100 is a device which acquires information of every kind through a radio communication net (a communication net such as a mobile phone net, VICS (a registered trademark) or DSRC (a registered trademark)). The communication device 100 may have an inter-vehicle communication function or a road-vehicle communication function. By having the inter-vehicle communication function or road-vehicle communication function, for example, it becomes possible to acquire road environment information (such as lane restriction information) of the path of the vehicle through the road-vehicle communication with a road side transmitter-receiver (such as a light beacon or an ITS spot (a registered trademark)) located on the side of the road. Or through the inter-vehicle communication, it becomes possible to acquire information concerning other vehicles (such as position information and information of traveling control) or road environment information detected by the other vehicles.

The operation switching support device 10 according to the first embodiment is described below with reference to the block diagram shown in FIG. 2.

The operation switching support device 10 has a driver state detecting part 11, a visual line detecting part 12, a driver state deciding part 13, a visual confirmation area deciding part 14, an area checking urging processing part 15, a visual confirmation deciding part 16, a switching permission signal output part 17, and a switching non-permission signal output part 18. The function of each of these parts is implemented, for example, by the control part 10a.

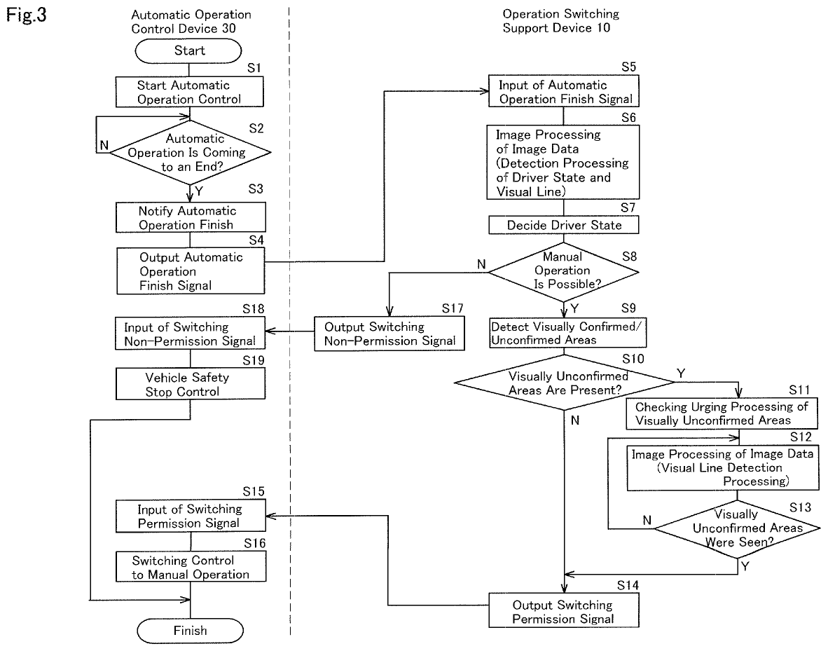

The driver state detecting part 11 conducts image processing of image data acquired from the driver monitoring device 20 before switching to manual operation (before automatic operation is released), so as to detect a state of a driver. Before switching to manual operation means the timing of switching from automatic operation to manual operation. That is, for example, the timing when the operation switching support device 10 had an input of an automatic operation finish signal output from the automatic operation control device 30. Specifically, that is the timing when the below-described processing in steps S4 and S5 shown in FIG. 3 is carried out. As the image processing method for detecting the driver state, various kinds of techniques can be adopted. For example, from the image data, feature quantities expressing the outline, direction, position and movement of the face of the driver, and the blink motion thereof are extracted and analyzed.

The visual line detecting part 12 conducts image processing of the image data acquired from the driver monitoring device 20 before switching to the manual operation, so as to detect a visual line of the driver. As the image processing method for detecting the visual line of the driver, various kinds of techniques can be adopted. For example, on the basis of the position relationship between a reference point (a portion which does not move) and a moving point (a portion which moves) in an eye part of the driver's image, the movement of the visual line is detected. In the case of using a visible light camera, for example, by setting the reference point to be the inner corner of the eye and the moving point to be the iris, the position relationship therebetween is detected. In the case of using an infrared light camera, by setting the reference point to be a corneal reflex and the moving point to be the pupil, the position relationship therebetween is detected.

The driver state deciding part 13 decides a state of the driver using the data representing the state of the driver detected by the driver state detecting part 11, so as to decide whether the driver is in a state of being able to perform manual operation. The driver state includes, for example, a state of looking ahead, a state of looking aside, a state of working (reading, eating and drinking, playing a game, operating a smart phone and the like) without looking ahead, a state of feeling sleepy, a state of falling asleep, and a state of a fit of a sudden illness or a panic. The driver state deciding part 13 decides that the driver is in the state of being able to perform manual operation, for example, in a case where the driver is looking ahead.

The visual confirmation area deciding part 14 distinguishes between areas visually confirmed by the driver and areas visually unconfirmed thereby, using the visual line data of the driver detected by the visual line detecting part 12, so as to decide the presence or absence of areas visually unconfirmed. For example, areas to be visually confirmed (e.g., areas in the front, in a left forward direction, in a right forward direction, in the neighborhood of a room mirror, in the neighborhoods of left and right side mirrors, behind and to the right, and behind and to the left) are previously selected. And whether the visual line was directed to each area of these with a fixed frequency or for a fixed period of time is decided using the detection data of the visual line, so that areas visually confirmed and areas visually unconfirmed are distinguished. In addition, in the selection of the areas to be visually confirmed, the size or position of each area may be varied according to changes in traveling circumstances (such as an ordinary road, an expressway, the number of lanes, weather (such as fine weather, rain, snow or fog), or time zone (such as day or night).

The area checking urging processing part 15 conducts processing of urging checking of the areas visually unconfirmed, when the driver is decided to be in the state of being able to perform manual operation by the driver state deciding part 13 and the areas visually unconfirmed are decided to be present by the visual confirmation area deciding part 14. When it is decided that the area in the neighborhood of the left side mirror has not been visually confirmed, for example, notification processing of outputting an announcement such as “Please check the rear through the left side mirror.” from the voice output part 92 is conducted.

After the urging processing by the area checking urging processing part 15, the visual line detecting part 12 conducts image processing of the image data acquired from the driver monitoring device 20, so as to detect the movement of the visual line of the driver. The visual confirmation deciding part 16 decides whether the areas visually unconfirmed were visually confirmed by the driver, using the visual line data detected by the visual line detecting part 12.

The switching permission signal output part 17 outputs a signal for permitting switching from automatic operation to manual operation (a switching permission signal) to the automatic operation control device 30, when it is decided that the areas visually unconfirmed were visually confirmed by the driver by the visual confirmation deciding part 16.

Or the switching permission signal output part 17 outputs a signal for permitting the switching to the automatic operation control device 30, when the driver is decided to be in the state of being able to perform manual operation by the driver state deciding part 13 and it is decided that there is no area visually unconfirmed by the visual confirmation area deciding part 14.

Or the switching non-permission signal output part 18 outputs a signal for not permitting the switching to manual operation (a switching non-permission signal) to the automatic operation control device 30, when the driver is decided not to be in the state of being able to perform manual operation (e.g., to be in a state of falling asleep, a state of a fit of a sudden illness or a panic) by the driver state deciding part 13.

FIG. 3 is a flowchart showing processing operations conducted by the operation switching support device 10 according to the first embodiment and the automatic operation control device 30. The first embodiment is described, assuming a case where a planned traveling route to a destination includes an expressway and an automatic operation section is set to be from an IC (interchange) entrance (main line entrance) of the expressway to an IC exit (main line exit) thereof, but the automatic operation section is not limited to this.

First, in step S1, the automatic operation control device 30 conducts processing of starting automatic operation control so as to start the automatic operation control. When a predetermined transfer condition from manual operation to automatic operation is satisfied after merging with main line traffic of the expressway, for example, the automatic operation control is automatically started. Or when the predetermined transfer condition from manual operation to automatic operation is satisfied after an operation (a manual operation) of an automatic operation switching button not shown was carried out, the automatic operation control may be started.

In step S2, whether the automatic operation is coming to an end is judged. For example, on the basis of position information of the vehicle or transfer point information from automatic operation to manual operation, received from the navigation system 80, whether the vehicle reached just before the automatic operation finish point (transfer point) is judged. Specifically, when the automatic operation possible section is set to be from the IC entrance of the expressway to the IC exit thereof, whether the vehicle reached a prescribed point just before the IC exit of the expressway, or whether a predicted time to reach the IC exit decreased below a prescribed time is judged.

When it is judged that the automatic operation is coming to an end in step S2, the operation goes to step S3, wherein notification processing of notifying the automatic operation finish (release) is conducted. For example, processing of allowing the voice output part 92 to output a voice announcement “The automatic operation section will come to an end soon. Please get ready for manual operation.” is conducted, and the operation goes to step S4. In step S4, an automatic operation finish signal is output to the operation switching support device 10.

In step S5, the operation switching support device 10 has an input of the automatic operation finish signal from the automatic operation control device 30, and the operation goes to step S6. In step S6, image processing of image data acquired from the driver monitoring device 20, that is, image processing for detecting the state of the driver and image processing for detecting the visual line thereof are conducted, and the operation goes to step S7. In the image processing of the image data in step S6, image data after the input of the automatic operation finish signal may be used, or image data (recorded data) before (immediately before) the input of the automatic operation release signal may be used.

In step S7, the driver state is decided using the data of the driver state detected in step S6, and the operation goes to step S8. The driver state detected in step S6 includes, for example, information of the position, direction or movement of the face of the driver, or the movement of eyelids (a blink). In step S7, from these items of information, the driver state is decided to be a state of looking ahead, looking aside, working (reading, eating and drinking, playing a game, operating a smart phone and the like) without looking ahead, feeling sleepy, falling asleep, or a fit of a sudden illness or a panic.

In step S8, whether the driver state is a state of being able to perform manual operation is decided, and when the driver is decided to be in the state of being able to perform manual operation, the operation goes to step S9. In the state of being able to perform manual operation, a state where the face of the driver is directed to the front is included. A state where the driver's attitude can be turned to the state of being able to perform manual operation within a short time, such as a state where the driver is doing another work (such as reading, eating and drinking, playing a game, operating a smart phone and the like) with the body thereof being directed to the front, may also be included. Or in the decision in step S8, besides the data picked up by the camera 21 of the driver monitoring device 20, detection data of the driver state obtained from a steering wheel contact sensor, a seating sensor or a vital information sensor, none of them shown, may be combined for the decision.

In step S9, using the visual line data detected by the visual line detecting part 12, areas visually confirmed by the driver (hereinafter, referred to as visual confirmation areas) and areas visually unconfirmed thereby (hereinafter, referred to as visually unconfirmed areas) are detected. As areas to be visually confirmed, for example, areas in the front of the vehicle, in a left forward direction, in a right forward direction, in the neighborhood of the room mirror, in the neighborhoods of the left and right side mirrors, behind and to the right, behind and to the left (a blind spot) and the like are previously selected. And whether the visual line was directed to each of these areas with a fixed frequency or for a fixed period of time is decided from the visual line data, so as to decide the visual confirmation areas and the visually unconfirmed areas.

In step S10, whether there is/are areas visually unconfirmed (visually unconfirmed areas) is decided, and when it is decided that there is/are visually unconfirmed areas, the operation goes to step S11, wherein processing of urging checking of the visually unconfirmed area(s) (area checking urging processing) is conducted. When the visually unconfirmed area is in the neighborhood of the right side mirror, for example, notification processing of allowing the voice output part 92 to output a voice announcement “Please check the rear through the right side mirror.” is conducted.

In step S12, after the checking urging processing of the visually unconfirmed area(s), image processing of the image data acquired from the driver monitoring device 20 is conducted so as to detect the visual line of the driver. In step S13, using the detection data of the visual line, whether the visually unconfirmed area/areas notified in step S11 were visually confirmed by the driver is decided. When it is decided that the visually unconfirmed area/areas were visually confirmed, the operation goes to step S14, while when it is decided that the visually unconfirmed area/areas have not been visually confirmed yet, the operation returns to step S12 and the processing is repeated. In step S14, a signal for permitting the switching from automatic operation to manual operation (a switching permission signal) is output to the automatic operation control device 30.

On the other hand, when it is decided that there is no visually unconfirmed area in step S10, the operation goes to step S14, wherein a signal for permitting the switching from automatic operation to manual operation is output to the automatic operation control device 30.

In step S15, the automatic operation control device 30 has an input of the switching permission signal from the operation switching support device 10. And in step S16, processing of finishing (releasing) the automatic operation control and switching from automatic operation to traveling control by manual operation is carried out, and thereafter, the processing is finished.

On the other hand, when it is decided that the driver is not in the state of being able to perform manual operation, for example, that the driver is in a state of falling asleep, a fit of a sudden illness or a panic in step S8, the operation goes to step S17. In step S17, a signal for not permitting the switching from automatic operation to manual operation (a switching non-permission signal) is output to the automatic operation control device 30.

In step S18, the automatic operation control device 30 has an input of the switching non-permission signal from the operation switching support device 10, and in step S19, on the basis of the switching non-permission signal, control to stop the vehicle in a safe place (such as the shoulder of a road) is carried out, and thereafter, the processing is finished.

In place of the above steps S12 and S13, whether a prescribed time (a time required to check the visually unconfirmed area(s)) elapsed after the checking urging processing of the visually unconfirmed area(s) in step S11 may be judged, and when it is judged that the prescribed time elapsed, the operation may go to step S14, wherein a switching permission signal is output.

Using the operation switching support device 10 according to the first embodiment, when the driver is decided to be in the state of being able to perform manual operation by the driver state deciding part 13 and it is decided that there is/are visually unconfirmed areas by the visual confirmation area deciding part 14, the processing of urging checking of the visually unconfirmed area(s) is conducted by the area checking urging processing part 15. Consequently, it is possible to conduct appropriate notification for letting the driver check the safety around the vehicle when switching to manual operation.

Therefore, when switching to manual operation, the driver can check all the surroundings of the vehicle by looking at the visually unconfirmed area(s) the checking of which was urged. Some of the load of safety checking motion is taken off the driver, leading to safe switching to manual operation just with required checking motions without taking much time and effort.

And when it is decided that the visually unconfirmed area/areas were visually confirmed by the driver by the visual confirmation deciding part 16, a switching permission signal to manual operation is output to the automatic operation control device 30. Consequently, after the driver's checking of all the surroundings of the vehicle, the switching to manual operation can be conducted, leading to enhanced safety.

And when the driver is decided to be in the state of being able to perform manual operation by the driver state deciding part 13 and it is decided that there is no visually unconfirmed area by the visual confirmation area deciding part 14, that is, when the driver is in the state of being able to perform manual operation and all the surroundings of the vehicle have been confirmed by the driver, it is possible to swiftly switch to manual operation without forcing the driver to check safety again.

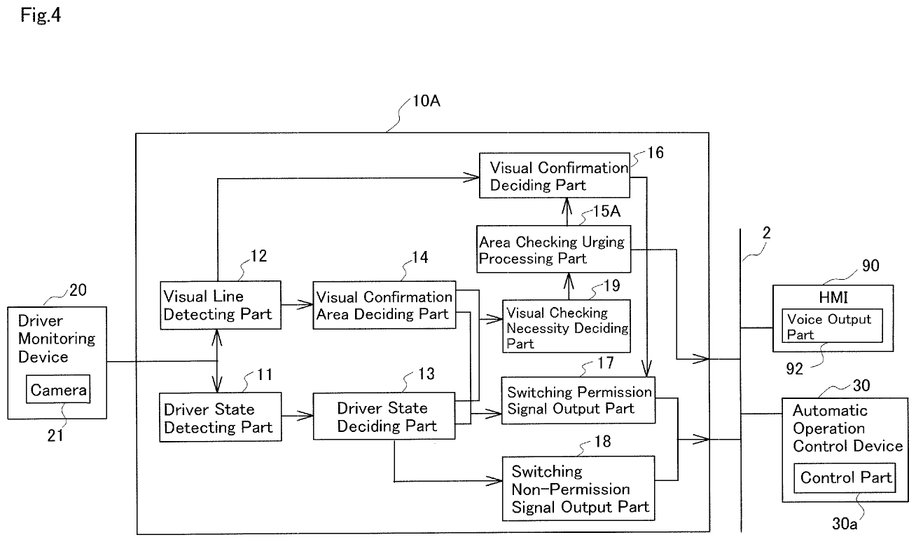

FIG. 4 is a block diagram schematically showing a construction of an operation switching support device according to a second embodiment. The components having the same functions as the operation switching support device according to the first embodiment shown in FIG. 2 are similarly marked, and not described here.

A different point of the operation switching support device 10A according to the second embodiment from the operation switching support device 10 according to the first embodiment is that it has a visual checking necessity deciding part 19.

When it is decided that there is/are visually unconfirmed areas by a visual confirmation area deciding part 14, the visual checking necessity deciding part 19 decides whether the visually unconfirmed area/areas need visual checking. Whether the visually unconfirmed area is an area needing visual checking is decided using at least one of planned traveling route data of a vehicle (including its own position and traveling lane) acquired from a navigation system 80 and detection data of objects existing in the periphery of the vehicle acquired from a periphery monitoring sensor 74 or through a communication device 100.

An area checking urging processing part 15A conducts processing of urging checking of the area(s) decided to need visual checking by the visual checking necessity deciding part 19 among the visually unconfirmed areas. As for the area(s) not needing visual checking among the visually unconfirmed areas, for example, the notification that in the direction of ◯◯ (the visually unconfirmed area), it is safe (e.g., no other vehicle is running) may be conducted. With such notification, the driver can feel safety without visual checking.

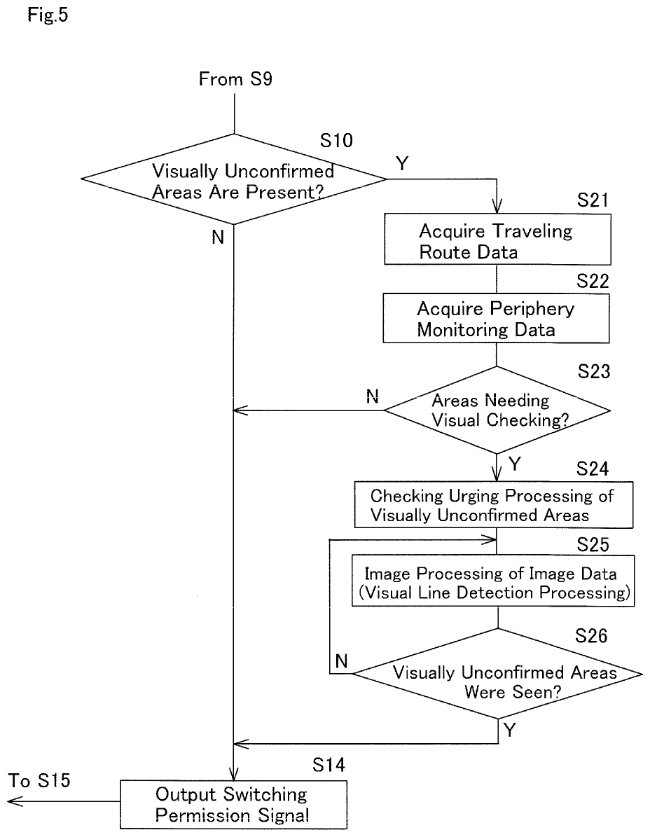

FIG. 5 is a flowchart showing processing operations conducted by the operation switching support device 10A according to the second embodiment. The processing operations from the beginning to step S10, and S14 and thereafter are the same as those shown in FIG. 3, and are not described here.

The second embodiment is described, assuming a case where a planned traveling route to a destination includes an expressway and an automatic operation section is set to be from an IC (interchange) entrance (main line entrance) of the expressway to an IC exit (main line exit) thereof, the vehicle is traveling by automatic operation on the middle lane of the road with three lanes in each direction, and when approaching the IC exit, the automatic operation is transferred to manual operation. But the case is not limited to this.

In the operation switching support device 10A, in step S10, whether there is/are visually unconfirmed areas is decided, and when it is decided that there is/are visually unconfirmed areas, the operation goes to step S21. In step S21, a traveling route (including road lane data planned to travel on) is acquired from the navigation system 80, and the operation goes to step S22. In step S22, detection data of objects existing in the periphery of the vehicle is acquired from the periphery monitoring sensor 74, and the operation goes to step S23. Here, in step S22, further information of the objects existing in the periphery of the vehicle may be acquired from the outside through the communication device 100.

In step S23, using at least one of the planned traveling route data of the vehicle and the detection data of the objects existing in the periphery of the vehicle, whether the visually unconfirmed area/areas need visual checking (in other words, whether there is an object in the visually unconfirmed area(s)) is decided.

In a case where the vehicle is traveling on the middle lane of the road with three lanes in each direction and the vehicle is to leave the expressway at an IC exit on the left side in the planned traveling route, for example, one other vehicle is running ahead on the same lane, one other vehicle is running in the rear on the left lane, and no vehicle is running in the front and rear on the right lane. In such situation, when the visually unconfirmed area is in the neighborhood of the right side mirror, it is decided that that is not an area needing visual checking (that is an area the safety of which is confirmed without visual checking), since no vehicle is running in the front and rear on the right lane. On the other hand, when the visually unconfirmed area is in the neighborhood of the left side mirror, it is decided that that is an area needing visual checking (an area the safety of which needs to be visually checked), since one other vehicle is running in the rear on the left lane and it is necessary to make a lane change to the left lane in order to leave the expressway at the IC exit.

In step S23, when it is decided that the visually unconfirmed area/areas do not need visual checking (in other words, there is no object in the visually unconfirmed area(s)), the operation goes to step S14. On the other hand, in step S23, when it is decided that the visually unconfirmed area/areas need visual checking (in other words, there is an object in the visually unconfirmed area(s)), the operation goes to step S24, wherein the processing of urging checking of the visually unconfirmed area(s) is conducted. For example, when the visually unconfirmed area in the above second embodiment is the left side mirror area, notification processing is conducted by outputting a voice announcement “Please check the rear through the left side mirror.” from the voice output part 92.

After the checking urging processing of the visually unconfirmed area(s) in step S24, the operation goes to step S25, wherein image processing is conducted on image data acquired from a driver monitoring device 20 in a visual line detecting part 12 so as to detect a visual line of a driver. In step S26, using the visual line detection data, whether the driver visually confirmed the visually unconfirmed area(s) notified in step S24 is decided. When it is decided that the visually unconfirmed area/areas were visually confirmed, the operation goes to step S14, while when it is decided that the visually unconfirmed area/areas have not been visually confirmed, the operation returns to step S25 and the processing is repeated. In step S14, a signal for permitting the switching from automatic operation to manual operation is output to an automatic operation control device 30.

Using the operation switching support device 10A according to the above second embodiment, when it is decided that there is/are visually unconfirmed areas, whether the visually unconfirmed area/areas need visual checking is decided. And among the visually unconfirmed areas, checking of the visually unconfirmed area/areas which were decided to need visual checking is urged. Consequently, the driver only has to check the area/areas which were decided to need visual checking. When switching to manual operation, some of the load of safety checking motion can be further taken off the driver without loss of safety.

And since whether the visually unconfirmed area/areas need visual checking is decided using the planned traveling route data of the vehicle or the detection data of the objects to be monitored, the decision is conducted with giving sufficient consideration to risk predicted during traveling of the vehicle. Therefore, it is possible to appropriately notify only the area(s) necessary for safety confirmation.

Part of or all of the functions of the above operation switching support device 10 or 10A may be incorporated into the automatic operation control device 30. Or part of or all of the functions of the above operation switching support device 10 or 10A may be incorporated into the navigation system 80.

### Addition 1

An operation switching support device for supporting switching from automatic operation in which traveling control of a vehicle is automatically conducted to manual operation by a driver, having a storage part and a hardware processor:

the storage part having,

a driver state detection data storing part for storing data detected by a driver state detecting part for detecting a state of the driver, and

a visual line detection data storing part for storing data detected by a visual line detecting part for detecting a visual line of the driver; and

the hardware processor,

deciding whether the driver is in a state of being able to perform the manual operation using the data detected by the driver state detecting part, before switching to the manual operation,

deciding the presence or absence of areas visually unconfirmed by the driver using the data detected by the visual line detecting part, before switching to the manual operation,

conducting urging processing of urging checking of the areas visually unconfirmed, when the driver is decided to be in the state of being able to perform the manual operation and the areas visually unconfirmed are decided to be present, and

outputting a signal for permitting switching from the automatic operation to the manual operation to an automatic operation control part, when a predetermined condition is satisfied after the urging processing.

### Addition 2

An operation switching support method conducted by a hardware processor to be mounted on a vehicle switchable from automatic operation in which traveling control of the vehicle is automatically conducted to manual operation by a driver, comprising the steps at least one hardware processor conducts:

the step of deciding whether the driver is in a state of being able to perform the manual operation using data detected by a driver state detecting part for detecting a state of the driver, before switching to the manual operation;

the step of deciding the presence or absence of areas visually unconfirmed by the driver using data detected by a visual line detecting part for detecting a visual line of the driver, before switching to the manual operation;

the step of conducting urging processing of urging checking of the areas visually unconfirmed, when the driver is decided to be in the state of being able to perform the manual operation and the areas visually unconfirmed are decided to be present; and

the step of outputting a signal for permitting switching from the automatic operation to the manual operation to an automatic operation control part, when a predetermined condition is satisfied after the urging processing.

### INDUSTRIAL APPLICABILITY

The present invention may be widely applied to an automatic vehicle operation system which conducts control to switch from automatic operation to manual operation, and the like, chiefly in the field of automobile industry.

### DESCRIPTION OF REFERENCE SIGNS

1: Automatic vehicle operation system
10, 10A: Operation switching support device
11: Driver state detecting part
12: Visual line detecting part
13: Driver state deciding part
14: Visual confirmation area deciding part
15: Area checking urging processing part
16: Visual confirmation deciding part
17: Switching permission signal output part
18: Switching non-permission signal output part
19: Visual checking necessity deciding part
20: Driver monitoring device
30: Automatic operation control device
74: Periphery monitoring sensor
80: Navigation system
90: HMI
100: Communication device

1. An operation switching support device for supporting switching from automatic operation in which traveling control of a vehicle is automatically conducted to manual operation by a driver, comprising:
a driver state deciding part for deciding whether the driver is in a state of being able to perform the manual operation using data detected by a driver state detecting part for detecting a state of the driver, before switching to the manual operation;
a visual confirmation area deciding part for deciding the presence or absence of areas visually unconfirmed by the driver using data detected by a visual line detecting part for detecting a visual line of the driver, before switching to the manual operation;
an area checking urging processing part for conducting processing of urging checking of the areas visually unconfirmed, when the driver is decided to be in the state of being able to perform the manual operation by the driver state deciding part and the areas visually unconfirmed are decided to be present by the visual confirmation area deciding part; and
a signal output part for outputting a signal for permitting switching from the automatic operation to the manual operation to an automatic operation control part, when a predetermined condition is satisfied after the urging processing by the area checking urging processing part.

2. The operation switching support device according to claim 1, comprising:
a visual confirmation deciding part for deciding whether the areas visually unconfirmed were visually confirmed by the driver using the data detected by the visual line detecting part, after the urging processing by the area checking urging processing part, wherein
the predetermined condition is that it is decided that the areas visually unconfirmed were visually confirmed by the driver by the visual confirmation deciding part.

3. The operation switching support device according to claim 1, comprising:
a visual checking necessity deciding part for deciding whether the areas visually unconfirmed need visual checking, when the areas visually unconfirmed are decided to be present by the visual confirmation area deciding part, wherein
the area checking urging processing part conducts the processing of urging checking of the areas decided to need visual checking by the visual checking necessity deciding part, among the areas visually unconfirmed.

4. The operation switching support device according to claim 3, wherein the visual checking necessity deciding part decides whether the areas visually unconfirmed need visual checking, using at least one of planned traveling route data of the vehicle and detection data of objects to be monitored existing in the periphery of the vehicle.

5. The operation switching support device according to claim 1, wherein the signal output part outputs the signal for permitting the switching, when the driver is decided to be in the state of being able to perform the manual operation by the driver state deciding part and the areas visually unconfirmed are decided not to be present by the visual confirmation area deciding part.

6. An operation switching support method conducted by a computer to be mounted on a vehicle switchable from automatic operation in which traveling control of the vehicle is automatically conducted to manual operation by a driver, comprising the steps of:
driver state decision for deciding whether the driver is in a state of being able to perform the manual operation using data detected by a driver state detecting part for detecting a state of the driver, before switching to the manual operation;
visual confirmation area decision for deciding the presence or absence of areas visually unconfirmed by the driver using data detected by a visual line detecting part for detecting a visual line of the driver, before switching to the manual operation;
area checking urging processing for conducting processing of urging checking of the areas visually unconfirmed, when the driver is decided to be in the state of being able to perform the manual operation in the driver state decision step and the areas visually unconfirmed are decided to be present in the visual confirmation area decision step; and
signal output for outputting a signal for permitting switching from the automatic operation to the manual operation to an automatic operation control part, when a predetermined condition is satisfied after the urging processing in the area checking urging processing step.

7. The operation switching support device according to claim 2, comprising:
a visual checking necessity deciding part for deciding whether the areas visually unconfirmed need visual checking, when the areas visually unconfirmed are decided to be present by the visual confirmation area deciding part, wherein
the area checking urging processing part conducts the processing of urging checking of the areas decided to need visual checking by the visual checking necessity deciding part, among the areas visually unconfirmed.

8. The operation switching support device according to claim 7, wherein the visual checking necessity deciding part decides whether the areas visually unconfirmed need visual checking, using at least one of planned traveling route data of the vehicle and detection data of objects to be monitored existing in the periphery of the vehicle.

9. The operation switching support device according to claim 2, wherein the signal output part outputs the signal for permitting the switching, when the driver is decided to be in the state of being able to perform the manual operation by the driver state deciding part and the areas visually unconfirmed are decided not to be present by the visual confirmation area deciding part.

10. The operation switching support device according to claim 3, wherein the signal output part outputs the signal for permitting the switching, when the driver is decided to be in the state of being able to perform the manual operation by the driver state deciding part and the areas visually unconfirmed are decided not to be present by the visual confirmation area deciding part.

11. The operation switching support device according to claim 4, wherein the signal output part outputs the signal for permitting the switching, when the driver is decided to be in the state of being able to perform the manual operation by the driver state deciding part and the areas visually unconfirmed are decided not to be present by the visual confirmation area deciding part.

12. The operation switching support device according to claim 7, wherein the signal output part outputs the signal for permitting the switching, when the driver is decided to be in the state of being able to perform the manual operation by the driver state deciding part and the areas visually unconfirmed are decided not to be present by the visual confirmation area deciding part.

13. The operation switching support device according to claim 8, wherein the signal output part outputs the signal for permitting the switching, when the driver is decided to be in the state of being able to perform the manual operation by the driver state deciding part and the areas visually unconfirmed are decided not to be present by the visual confirmation area deciding part.
